(19) United States
(12) Patent Application Publication
(10) Pub. No.: US 2014/0129390 A1
(43) Pub. Date: May 8, 2014

(54) MATCHING BRANDS AND SIZES

(71) Applicants: Karin Mauge, Mountain View, CA (US); Neelakantan Sundaresan, Mountain View, CA (US); Amit Reuven Menipaz, Los Gatos, CA (US)

(72) Inventors: Karin Mauge, Mountain View, CA (US); Neelakantan Sundaresan, Mountain View, CA (US); Amit Reuven Menipaz, Los Gatos, CA (US)

(21) Appl. No.: 14/070,372

(22) Filed: Nov. 1, 2013

Related U.S. Application Data
(60) Provisional application No. 61/721,704, filed on Nov. 2, 2012.

(51) Int. Cl. G06Q 30/06

(52) U.S. Cl. CPC G06Q 30/0629
USPC 705/26.63

(57) ABSTRACT

Consumers face a problem matching brand and size of one product to a different brand and size of a related product because not all brands measure sizes in the same way. As such, internet commerce companies recommend shoe sizes to users based upon a user-specified size or a user-specified pair of the shoes and size in a brand that the user suggests. Data in a peer-to-peer marketplace is mined to determine corresponding shoe sizes across various brands.

### CLAIM OF PRIORITY

This application claims the benefit of priority to U.S. Provisional Patent Application Ser. No. 61/721,704, filed on Nov. 2, 2012, which is incorporated by reference herein in its entirety.

### BACKGROUND

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2012, All Rights Reserved.

### BRIEF DESCRIPTION OF THE DRAWINGS

Some embodiments are illustrated by way of example and not limitations in the figures of the accompanying drawings, in which:

FIG. 1 illustrates a block diagram depicting a network architecture of a system, according to some embodiments, having a client-server architecture configured for exchanging data over a network.

FIG. 2 illustrates a block diagram showing components provided within the system of FIG. 1 according to some embodiments.

FIG. 3 illustrates a more detailed diagram showing components provided within the system of FIG. 1 according to some embodiments.

FIG. 4 is a flowchart of an example embodiment.

FIG. 5 illustrates a diagrammatic representation of a machine in the example form of a computer system within which a set of instructions may be executed to cause the machine to perform any one or more of the methodologies discussed herein.

The headings provided herein are for convenience only and do not necessarily affect the scope or meaning of the terms used.

### DESCRIPTION

Example methods and systems to match brands and sizes are described. In the following description, for purposes of explanation, numerous specific details are set forth in order to provide a thorough understanding of example embodiments. It will be evident, however, to one skilled in the art that the present invention may be practiced without these specific details.

One of the important problems in the marketplace is matching brand and size of one product to a different brand and size of a related product. Consider the following example: A user who buys Nike Lunar Guide running shoes size 9W might seek a substitute brand for the same purpose or the same or a different brand for a different purpose. For instance, the user may be interested in buying a pair of Reeboks running shoes or Clarks dress shoes that fit the same individual. Since shoe sizes vary significantly across brands and across models and across purposes, this becomes a challenging problem. One of the challenges for internet commerce companies is to recommend the right size shoes to users based upon the user-specified size or a user-specified pair of the shoes and size in a brand that the user suggests.

Companies like Zappos offer features where the user can return the shoes within a year and they charge a premium on the price because of this service. Still, the user may not be happy to find that the pair that arrived is needed for an immediate event and they have to return it to the seller.

There are a few sites online that help with shoe sizes across countries. There are some sites that host 10-20 brands of shoes and provide pre-defined conversions to users.

A technology for the application scenarios in Table 1 is provided:

TABLE 1

| | |
|---|---|
| 1. | A user whose standardized shoe size is known would like to buy |
| | a certain brand of shoes, and needs to know what size to buy |
| | in that brand. |
| 2. | A user who owns a certain brand/model of shoes in a certain size |
| | for a certain purpose, and the user is to be recommended a |
| | different brand/model of shoes in an appropriate size for the |
| | same purpose. |
| 3. | A user who owns a certain brand/model of shoes in a certain size |
| | for a certain purpose, and the user is to be recommended a |
| | different brand/model of shoes in an appropriate size for a |
| | different purpose. |

A data mining and reputation-based approach to match brand/model and size for a particular product to recommend, for example, shoe sizes is described herein.

In a peer-to-peer marketplace and the space of user-generated content, a lot of noisy data is available. Cleaning and appropriately using this data to extract the right kind of information allows the peer-to-peer marketplace to make recommendations. The six sources of data that can be used, mined, and validated to make recommendations are seen in Table 2.

TABLE 2

| | |
|---|---|
| 1. | Product title data |
| 2. | Product description data |
| 3. | User behavior data |
| 4. | User transaction history data |
| 5. | User advanced query data |
| 6. | Review data |

Additional details about these sources of data are described below.

Product Title Data:

Product title data is provided by a seller selling the shoes. The seller is rightfully incented to provide correct information so that the potential buyer buys the appropriate product and is happy about it. Any information the seller provides in the title of the product may be used. Some examples include:

TABLE 3

| | |
|---|---|
| Women's Skechers Shoe SZ | (Here the seller notes that this |
| 6 Purple Suede FITS LIKE | woman's Skechers size 6 suede shoes |
| A SIZE 7 | are more like a standard size 7.) |
| Urban Outfitters BDG Suede | (Here the seller notes that |
| Pumps Navy blue 7.5-fits | this brand and type of shoe |
| like 8 | in size 7.5 is more like a |
| | standard size 8. |

By mining the brand model and size data, a dictionary and scores of the mappings are generated. As more and more listings of this kind are seen, additional information as to the size mappings or offsets in sizes (+0.5 or −0.5 etc.) is gleaned. We also use the reputation of the seller, the conversion ratio, and/or buyer feedback to strengthen the results of the mining.

Product Description Data:

Since product titles are short, additional information may be provided in item-specifics or in descriptions of the items. By mining phrases in the descriptions or by mining tables in the descriptions for mapping information, we can further strengthen the information. Below is a snippet of a description from a seller listing:

Women's Merrell Encore Maryjanes in a Size 6
Beige mesh/synthetic leather uppers
Mesh lined
Removable OrthoLite Air Cushion insoles
Rubber Air Cushion soles with extended toes and heels for added protection
Adjustable velcroe strap with buckle
Vegan friendly footwear:)
These are pre-owned and in outstanding condition!!So many miles left to walk in these adorable maryjanes. Slight wear on insoles and ankle collar where you slide in. Merrell is known for extreme comfort and quality—get that here for a fraction of retail pricing!
**Please note, these are marked a size 6 but truly fit like a 6.5: toe to heel on the insole they measure approx. 9.5″.

User Behavior Data:

Searching the trails of users also provides some information on what may be related. For instance, a user searching for a certain brand of shoes of a certain size may look at various result sets. Based on that research, the user may correct the search query to the same brand with a different size or to a different brand and same or different size. By “search trail” mining over large periods of data, we can extract pairs of data that are related—same or different brand shoes and sizes.

User Transaction History Data.

Passionate users collect shoes. Passionate eBay users repeatedly buy shoes for different purposes from same or different brands. By mining transaction data from users of this kind, we can again find out what size the user wears and the different brands and purposes for which the user buys shoes. We can correlate the data by removing the outliers (the same user may buy for a spouse or kids which are likely different sizes). Also, getting signals from large number of users and getting the idea of size differences help us fill the matrix of shoes and size relationships.

Advance Query Data:

Some expert users who are aware of size matches across brands will create and save and repeatedly use complex queries to find substitutes for shoes and sizes they may be interested in.

Product Review Data:

In product review or user feedback data users who bought shoes specify whether the shoe is a fit for a certain standard size or not. On some sites, like zappos.com they explicitly ask user to provide ratings on shoe sizes, width, fit, and comfort. By mining this data for quality of users who produced the ratings composed with information on users who vouched this rating we can produce a mapping table of shoe brands and sizes.

Thus, a method that mines these data sources to combine signals/data from these data sources to extract mapping for shoe brands and sizes is described.

In another embodiment, point of sale data is leveraged across millions of customers to mine for ‘true fitment’ of products or brand/model/style/size combinations in order to create sets of inventory from our total inventory that would represent a ‘true fit’ for a buyer by inferring it through a shared purchases with other buyers who have some of their purchases in common.

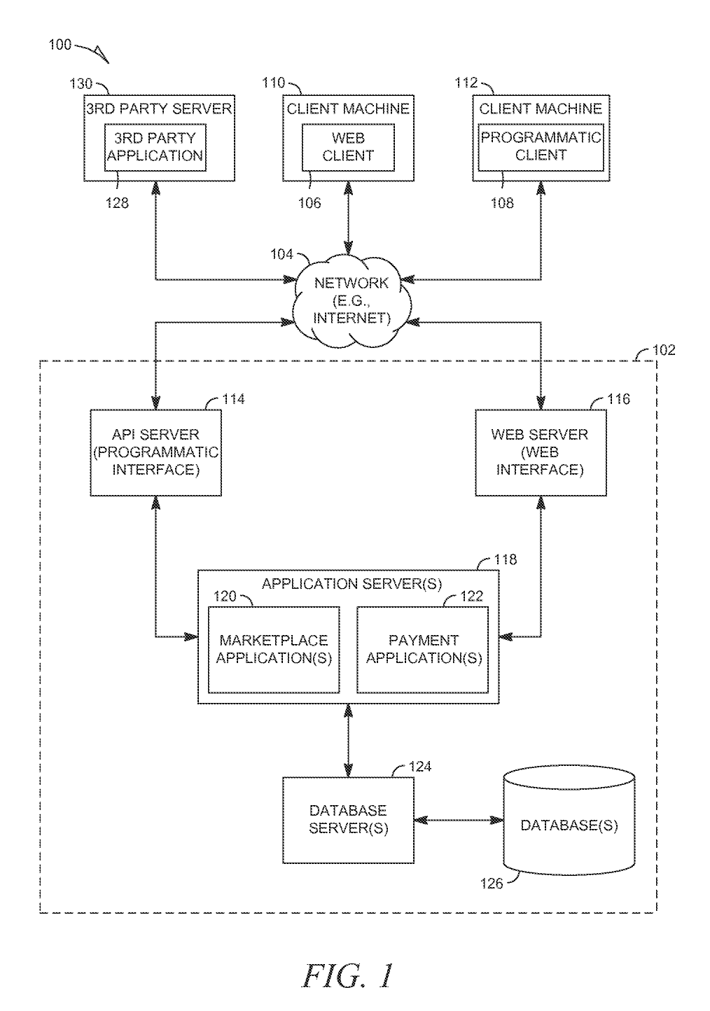

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. The network system may be referred to herein as a publisher because the networked system, in some embodiments, may be a publication system. FIG. 1 illustrates, for example, a web client 106 (e.g., a browser), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

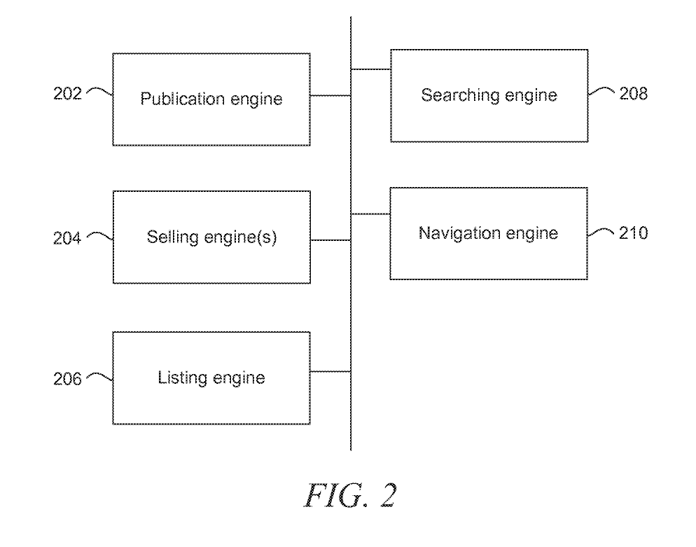

FIG. 2 illustrates a block diagram showing components provided within the networked system 102 according to some embodiments. The networked system 102 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 126 via the database servers 124.

The networked system 102 may provide a number of publishing, listing, and/or price-setting mechanisms whereby a seller (also referred to as a first user) may list (or publish information concerning) goods or services for sale or barter, a buyer (also referred to as a second user) can express interest in or indicate a desire to purchase or barter such goods or services, and a transaction (such as a trade) may be completed pertaining to the goods or services. To this end, the networked system 102 may comprise at least one publication engine 202 and one or more selling engines 204. The publication engine 202 may publish information, such as item listings or product description pages, on the networked system 102. In some embodiments, the selling engines 204 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the networked system 102. In some embodiments, the listings may be an offer, deal, coupon, or discount for the good or service. Each good or service is associated with a particular category. The listing engine 206 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the networked system 102 (e.g., databases 126). Listings also may comprise product description pages that display a product and information (e.g., product title, specifications, and reviews) associated with the product. In some embodiments, the product description page may include an aggregation of item listings that correspond to the product described on the product description page.

The listing engine 206 also may allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 206 may receive as much or as little listing data, such as title, description, and aspect name/value pairs, that the buyer is aware of about the requested item. In some embodiments, the listing engine 206 may parse the buyer's submitted item information and may complete incomplete portions of the listing. For example, if the buyer provides a brief description of a requested item, the listing engine 206 may parse the description, extract key terms and use those terms to make a determination of the identity of the item. Using the determined item identity, the listing engine 206 may retrieve additional item details for inclusion in the buyer item request. In some embodiments, the listing engine 206 may assign an item identifier to each listing for a good or service.

In some embodiments, the listing engine 206 allows sellers to generate offers for discounts on products or services. The listing engine 206 may receive listing data, such as the product or service being offered, a price and/or discount for the product or service, a time period for which the offer is valid, and so forth. In some embodiments, the listing engine 206 permits sellers to generate offers from the sellers' mobile devices. The generated offers may be uploaded to the networked system 102 for storage and tracking.

Searching the networked system 102 is facilitated by a searching engine 208. For example, the searching engine 208 enables keyword queries of listings published via the networked system 102. In example embodiments, the searching engine 208 receives the keyword queries from a device of a user and conducts a review of the storage device storing the listing information. The review will enable compilation of a result set of listings that may be sorted and returned to the client device (e.g., device machine 110, 112) of the user. The searching engine 208 may record the query (e.g., keywords) and any subsequent user actions and behaviors (e.g., navigations, selections, or click-throughs).

The searching engine 208 also may perform a search based on a location of the user. A user may access the searching engine 208 via a mobile device and generate a search query. Using the search query and the user's location, the searching engine 208 may return relevant search results for products, services, offers, auctions, and so forth to the user. The searching engine 208 may identify relevant search results both in a list form and graphically on a map. Selection of a graphical indicator on the map may provide additional details regarding the selected search result. In some embodiments, the user may specify, as part of the search query, a radius or distance from the user's current location to limit search results.

The searching engine 208 also may perform a search based on an image. The image may be taken from a camera or imaging component of a client device or may be accessed from storage.

In a further example, a navigation engine 210 allows users to navigate through various categories, catalogs, or inventory data structures according to which listings may be classified within the networked system 102. For example, the navigation engine 210 allows a user to successively navigate down a category tree comprising a hierarchy of categories (e.g., the category tree structure) until a particular set of listing is reached. Various other navigation applications within the navigation engine 210 may be provided to supplement the searching and browsing applications. The navigation engine 210 may record the various user actions (e.g., clicks) performed by the user in order to navigate down the category tree.

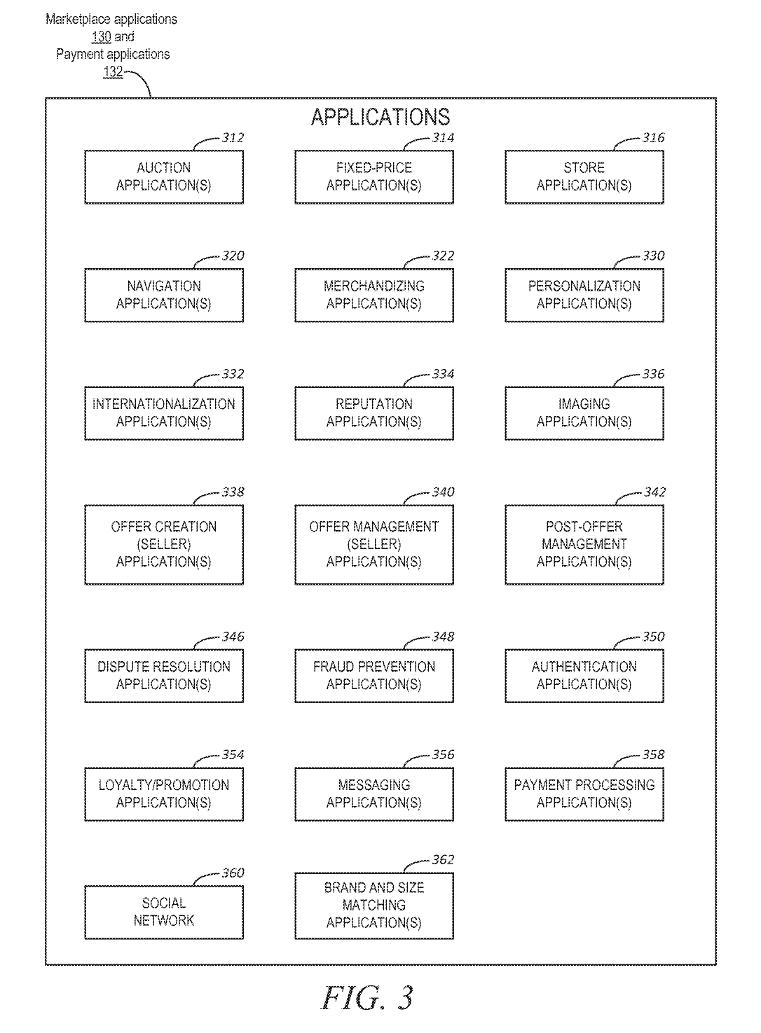

Additional modules and engines associated with the networked system 102 are described below in further detail. It should be appreciated that modules or engines may embody various aspects of the details described below. For instance, a more detailed written description of example notification example notification modules may be seen in FIG. 3 according to an example embodiment.

FIG. 3 illustrates a block diagram showing applications of application server(s) that are part of the network system 101, in an example embodiment. In this embodiment, the publication system 120, and the payment system 120 may be hosted by the application server(s) 118 of the network system 101. The publication system 120 and the payment system 122 may be hosted on dedicated or shared server machines (not shown) that are communicatively coupled to enable communications between server machines. The applications themselves may be communicatively coupled (e.g., via appropriate interfaces) to each other and to various data sources, so as to allow information to be passed between the applications or so as to allow the applications to share and access common data.

The publication system 120 are shown to include at least one or more auction application(s) 312 which support auction-format listing and price setting mechanisms (e.g., English, Dutch, Vickrey, Chinese, Double, Reverse auctions etc.). The auction application(s) 312 may also provide a number of features in support of such auction-format listings, such as a reserve price feature whereby a seller may specify a reserve price in connection with a listing and a proxy-bidding feature whereby a bidder may invoke automated proxy bidding. The auction-format offer in any format may be published in any virtual or physical marketplace medium and may be considered the point of sale for the commerce transaction between a seller and a buyer (or two users).

One or more fixed-price application(s) 314 support fixed-price listing formats (e.g., the traditional classified advertisement-type listing or a catalogue listing) and buyout-type listings. Specifically, buyout-type listings (e.g., including the Buy-It-Now® (BIN) technology developed by eBay Inc., of San Jose, Calif.) may be offered in conjunction with auction-format listings, and allow a buyer to purchase goods or services, which are also being offered for sale via an auction, for a fixed-price that may be typically higher than the starting price of the auction.

The application(s) of the application server(s) 118 may include one or more store application(s) 316 that allow a seller to group listings within a “virtual” store. The virtual store may be branded and otherwise personalized by and for the seller. Such a virtual store may also offer promotions, incentives and features that are specific and personalized to a relevant seller.

Navigation of the online marketplace may be facilitated by one or more navigation application(s) 320. For example, a search application (as an example of a navigation application) may enable key word searches of listings published via the network-based publisher 102. A browse application may allow users to browse various category, catalogue, or inventory data structures according to which listings may be classified within the network-based publisher 102. Various other navigation applications may be provided to supplement the search and browsing applications.

Merchandizing application(s) 322 support various merchandising functions that are made available to sellers to enable sellers to increase sales via the network-based publisher 102. The merchandizing application(s) 322 also operate the various merchandising features that may be invoked by sellers, and may monitor and track the success of merchandising strategies employed by sellers.

Personalization application(s) 330 allow users of the network-based publisher 102 to personalize various aspects of their interactions with the network-based publisher 102. For example, a user may, utilizing an appropriate personalization application 330, create a personalized reference page at which information regarding transactions to which the user may be (or has been) a party may be viewed. Further, the personalization application(s) 330 may enable a third party to personalize products and other aspects of their interactions with the network-based publisher 102 and other parties, or to provide other information, such as relevant business information about themselves.

The publication system 120 may include one or more internationalization application(s) 332. In one embodiment, the network-based publisher 102 may support a number of marketplaces that are customized, for example, for specific geographic regions. A version of the network-based publisher 102 may be customized for the United Kingdom, whereas another version of the network-based publisher 102 may be customized for the United States. Each of these versions may operate as an independent marketplace, or may be customized (or internationalized) presentations of a common underlying marketplace. The network-based publisher 102 may accordingly include a number of internationalization application(s) 332 that customize information (and/or the presentation of information) by the network-based publisher 102 according to predetermined criteria (e.g., geographic, demographic or marketplace criteria). For example, the internationalization application(s) 332 may be used to support the customization of information for a number of regional websites that are operated by the network-based publisher 102 and that are accessible via respective web servers.

Reputation application(s) 334 allow users that transact, utilizing the network-based publisher 102, to establish, build and maintain reputations, which may be made available and published to potential trading partners. Consider that where, for example, the network-based publisher 102 supports person-to-person trading, users may otherwise have no history or other reference information whereby the trustworthiness and credibility of potential trading partners may be assessed. The reputation application(s) 334 allow a user, for example through feedback provided by other transaction partners, to establish a reputation within the network-based publisher 102 over time. Other potential trading partners may then reference such a reputation for the purposes of assessing credibility and trustworthiness.

In order to make listings, available via the network-based publisher 102, as visually informing and attractive as possible, the publication system 120 may include one or more imaging application(s) 336 utilizing which users may upload images for inclusion within listings. An imaging application 336 also operates to incorporate images within viewed listings. The imaging application(s) 336 may also support one or more promotional features, such as image galleries that are presented to potential buyers. For example, sellers may generally pay an additional fee to have an image included within a gallery of images for promoted items.

The publication system 120 may include one or more offer creation application(s) 338. The offer creation application(s) 338 allow sellers conveniently to author products pertaining to goods or services that they wish to transact via the network-based publisher 102. Offer management application(s) 340 allow sellers to manage offers, such as goods, services, or donation opportunities. Specifically, where a particular seller has authored and/or published a large number of products, the management of such products may present a challenge. The offer management application(s) 340 provide a number of features (e.g., auto-reproduce, inventory level monitors, etc.) to assist the seller in managing such products. One or more post-offer management application(s) 342 also assist sellers with a number of activities that typically occur post-offer. For example, upon completion of an auction facilitated by one or more auction application(s) 312, a seller may wish to leave feedback regarding a particular buyer. To this end, a post-offer management application 342 may provide an interface to one or more reputation application(s) 334, so as to allow the seller conveniently to provide feedback regarding multiple buyers to the reputation application(s) 334.

The dispute resolution application(s) 346 may provide mechanisms whereby disputes arising between transacting parties may be resolved. For example, the dispute resolution application(s) 346 may provide guided procedures whereby the parties are guided through a number of steps in an attempt to settle a dispute. In the event that the dispute cannot be settled via the guided procedures, the dispute may be escalated to a mediator or arbitrator.

The fraud prevention application(s) 348 may implement various fraud detection and prevention mechanisms to reduce the occurrence of fraud within the network-based publisher 102. The fraud prevention application(s) may prevent fraud with respect to the third party and/or the client user in relation to any part of the request, payment, information flows and/or request fulfilment. Fraud may occur with respect to unauthorized use of financial instruments, non-delivery of goods, and abuse of personal information.

Authentication application(s) 350 may verify the identity of a user, and may be used in conjunction with the fraud prevention application(s) 348. The user may be requested to submit verification of identity, an identifier upon making the purchase request, for example. Verification may be made by a code entered by the user, a cookie retrieved from the device, a phone number/identification pair, a username/password pair, handwriting, and/or biometric methods, such as voice data, face data, iris data, finger print data, and hand data. In some embodiments, the user may not be permitted to login without appropriate authentication. The system (e.g., the FSP) may automatically recognize the user, based upon the particular network-based device used and a retrieved cookie, for example.

The network-based publisher 102 itself, or one or more parties that transact via the network-based publisher 102, may operate loyalty programs and other types of promotions that are supported by one or more loyalty/promotions application(s) 354. For example, a buyer/client user may earn loyalty or promotions points for each transaction established and/or concluded with a particular seller/third party, and may be offered a reward for which accumulated loyalty points can be redeemed.

The application server(s) 118 may include messaging application(s) 356. The messaging application(s) 356 are responsible for the generation and delivery of messages to client users and third parties of the network-based publisher 102. Information in these messages may be pertinent to services offered by, and activities performed via, the payment system 120. Such messages, for example, advise client users regarding the status of products (e.g., providing “out of stock” or “outbid” notices to client users) or payment status (e.g., providing invoice for payment, Notification of a Payment Received, delivery status, invoice notices). Third parties may be notified of a product order, payment confirmation and/or shipment information. Respective messaging application(s) 356 may utilize any one of a number of message delivery networks and platforms to deliver messages to users. For example, messaging application(s) 356 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

The payment system 120 may include one or more payment processing application(s) 358. The payment processing application(s) 358 may receive electronic invoices from the merchants and may receive payments associated with the electronic invoices. The payment system 120 may also make use of functions performed by some applications included in the publication system 120.

The publication system 120 may include one or more social network application(s) 360.

The publication system 120 may also include one or more category matcher application(s) 362 which may be used for mapping item categories to ambiguous search queries by geo-location, described in more detail with respect to embodiments described herein.

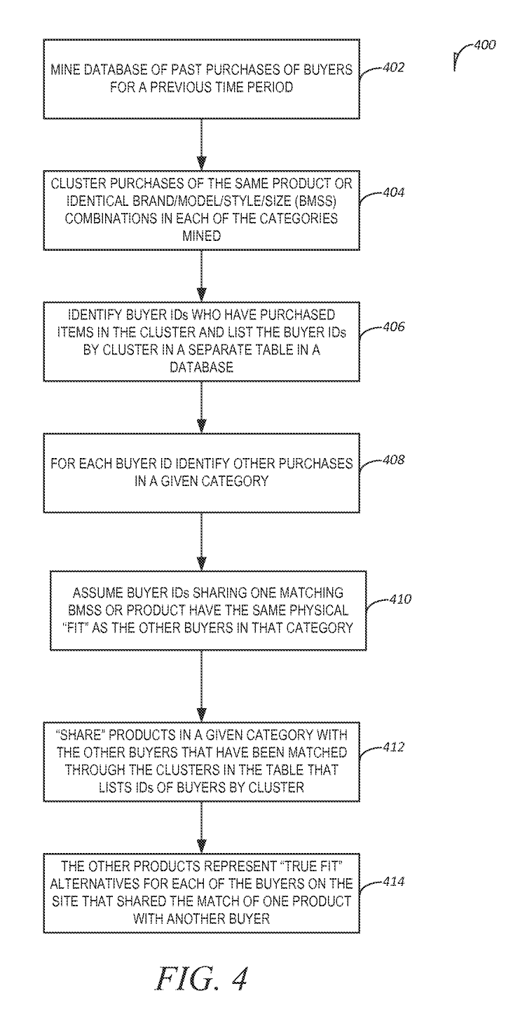

FIG. 4 is a diagram of an embodiment 400. At 402, the system may mine a database of past purchases of buyers for the past X years time period. At 404, the system may cluster purchases of the same Product or identical Brand/Model/Style/Size (BMSS) combinations in each of the categories. At 406, the system may identify Buyer IDs who have purchased items in the cluster and list the buyer IDs by cluster in a separate table. At 408, for each Buyer ID, the system may identify other purchases in a given category. At 410 the system may assume that Buyer IDs sharing one matching BMSS item or product have the same physical ‘fit’ as the other buyers within that category. To adequately cleanse the data, outlier logic may be used to identify events such as: returns (by reviewing returns for a given buyer and removing those ‘products’ from her bucket as a reference) or gift purchases for others (by noting if the size of a given purchases is materially different from most of their other purchases).

At 412 the system may “share” products in a given category with of the other buyers that have been matched through the clusters in table of step 406. As at 414, these other products represent “True Fit” alternatives for each of the buyers on the site that shared the match of one product with another buyer—basically we are aggregating the ‘closets’ of the buyers who share a common fit/affinity for a particular product or BMSS combination of items (Think of the analogy of shoes: I like a particular brand/model/style/size of running shoe and buy it, you like the same one and buy it. But each of us has other running, tennis, biking, etc. shoes. It is likely if I borrowed yours it would fit me comfortably).

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

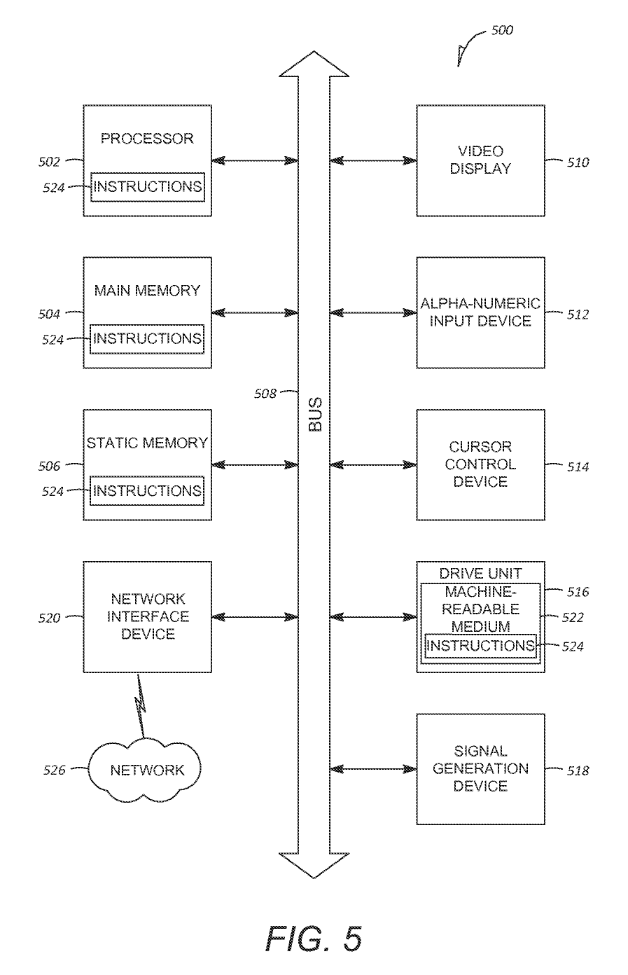

FIG. 5 is a block diagram of machine in the example form of a computer system 500 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard or a touch-sensitive display screen), a user interface (UI) navigation device 514 (e.g., a mouse), a disk drive unit 516, a signal generation device 518 (e.g., a speaker) and a network interface device 520.

### Machine-Readable Medium

The disk drive unit 516 includes a machine-readable medium 522 on which is stored one or more sets of instructions and data structures (e.g., software) 524 embodying or utilized by any one or more of the methodologies or functions described herein. The instructions 524 may also reside, completely or at least partially, within the main memory 504 and/or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 524 may further be transmitted or received over a communications network 526 using a transmission medium. The instructions 524 may be transmitted using the network interface device 520 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of matching brands and sizes for a type of product comprising:
mining from product listing data, by a computer processor, brand, model and size data of the product, the mining comprising:
mining a database of past purchases of buyers for a given time period;
clustering purchases of the same product or identical brand, model, style, and size combinations in each of the mined categories;
identifying buyers who have purchased items in the cluster and list the identified buyers by cluster in a table;
for identified buyers, identifying other purchases in a given category;
sharing products in the given category with other buyers that have been matched through the clusters in table; and
suggesting the other products as alternatives for buyers that shared the match of one product with another buyer.

2. The method of claim 1 where the data includes product description data.

3. The method of claim 1 wherein the data includes user behavior data.

4. The method of claim 1 wherein the data includes user transaction history data.

5. The method of claim 1 wherein the data includes advance query data.

6. The method of claim 1 wherein the data includes product review data

7. One or more computer-readable hardware storage devices having embedded therein a set of instructions which, when executed by one or more processors of a computer, causes the computer to execute operations comprising:
mining from product listing data, by a computer processor, brand, model and size data of the product, the mining comprising:
mining a database of past purchases of buyers for a given time period;
clustering purchases of the same product or identical brand, model, style, and size combinations in each of the mined categories;
identifying buyers who have purchased items in the cluster and list the identified buyers by cluster in a table;
for identified buyers, identifying other purchases in a given category;
sharing products in the given category with other buyers that have been matched through the clusters in table; and
suggesting the other products as alternatives for buyers that shared the match of one product with another buyer.

8. The one or more computer-readable hardware storage devices of claim 7 wherein the data includes product description data.

9. The one or more computer-readable storage device of claim 7 wherein the data includes user behavior data.

10. The one or more computer-readable storage device of claim 7 wherein the data includes user transaction history data.

11. The one or more computer-readable storage device of claim 7 wherein the data includes advance query data.

12. The one or more computer-readable storage device of claim 7 wherein the data includes product review data.

13. A system comprising:
one or more computer processors configured to
mine a database of past purchases of buyers for a given time period;
cluster purchases of the same product or identical brand, model, style, and size combinations in each of the mined categories;
identify buyers who have purchased items in the cluster and list the identified buyers by cluster in a table;
for identified buyers, identify other purchases in a given category;
share products in the given category with other buyers that have been matched through the clusters in table; and
suggest the other products as alternatives for buyers that shared the match of one product with another buyer.

14. The system of claim 13 wherein the data includes product description data.

15. The system of claim 13 wherein the data includes user behavior data.

16. The system of claim 13 wherein the data includes user transaction history data.

17. The system of claim 13 wherein the data includes advance query data.

18. The system of claim 13 wherein the data includes product review data.
